(19) United States
(12) Patent Application Publication
(10) Pub. No.: US 2013/0329174 A1
(43) Pub. Date: Dec. 12, 2013

(54) OPTICAL DEFLECTING ELEMENT

(71) Applicants: Yuuichi Kanbayashi, Osaka-shi (JP); Hiromi Katoh, Osaka-shi (JP); Naru Usukura, Osaka-shi (JP)

(72) Inventors: Yuuichi Kanbayashi, Osaka-shi (JP); Hiromi Katoh, Osaka-shi (JP); Naru Usukura, Osaka-shi (JP)

(73) Assignee: SHARP KABUSHIKI KAISHA, Osaka-shi, Osaka (JP)

(21) Appl. No.: 13/981,328

(22) PCT Filed: Jan. 24, 2012
(86) PCT No.: PCT/JP2012/051450

§ 371 Date: Jul. 24, 2013

(30) Foreign Application Priority Data
Jan. 26, 2011 (JP) 211-014114

(51) Int. Cl. G02F 1/1343; G02F 1/139

(52) U.S. Cl. CPC G02F 1/134309; G02F 1/139
USPC 349/127; 349/141

(57) ABSTRACT

An optical deflecting element (100A) according to the present invention is an optical deflecting element including a first substrate (11) on which a first electrode (10) is formed, a second substrate (21) on which a second electrode (20) is formed, and a liquid crystal layer (17) arranged between the first electrode (10) and the second electrode (20). At least one of the first electrode (10) and the second electrode (20) includes a plurality of first transparent electrodes (13), a plurality of second transparent electrodes (15), and an inter-layer film (14). The plurality of first transparent electrodes (13) and the plurality of second transparent electrodes (15) are alternately arranged in stripes. The inter-layer film (14) is formed on the plurality of first transparent electrodes (13). The plurality of second transparent electrodes (15) are formed on the inter-layer film (14).

### TECHNICAL FIELD

The present invention relates to an optical deflecting element.

### BACKGROUND ART

Optical deflecting elements using a liquid crystal material have been developed in recent years (for example, PTL 1).

PTL 1 discloses an optical deflecting device using a nematic liquid crystal material. Specifically, the optical deflecting device disclosed in PTL 1 has two insulating substrates (such as glass substrates) and a nematic liquid crystal layer, which is sandwiched between the two insulating substrates and which has homogeneous liquid crystal molecules. Further, a plurality of transparent electrodes arranged in stripes are formed on one insulating substrate, and an opposing electrode is formed on the other insulating substrate. The plurality of transparent electrodes arranged in stripes and the opposing electrode give rise to a periodical electric field intensity distribution in the nematic liquid crystal layer, thereby causing modulation of a spatial refractive index in the nematic liquid crystal layer. Such an optical deflecting device is expected to have a large deflection angle.

### CITATION LIST

### Patent Literature

PTL 1: Japanese Unexamined Patent Application Publication No. 2008-134625

### SUMMARY OF INVENTION

### Technical Problem

In the optical deflecting device disclosed in PTL 1, application of certain voltages to the transparent electrodes induces a spatial refractive index modulated region in the nematic liquid crystal layer, thereby forming a blazed diffraction grating. In this case, the relationship between a deflection angle (diffraction angle) θ and a grating pitch p is expressed by the following expressions (1)

θ=sin⁻¹(λ/p), 0°≦θ≦90°, λ: wavelength of incident light

Therefore, the smaller the grating pitch p, the greater the deflection angle θ.

FIG. 8 is a graph describing the relationship between the array pitch of the transparent electrodes (corresponding to the grating pitch) and the deflection angle (diffraction angle) of light with a wavelength of 550 nm.

As is clear from FIG. 8, when the wavelength of incident light is, for example, 550 nm (λ=550 nm), to have a deflection angle of 15° or greater, the transparent electrodes must be formed so that the array pitch thereof becomes about 1.0 μm.

However, in the electrode structure of the optical deflecting device disclosed in PTL 1, it is difficult to pattern the transparent electrodes in stripes so that the array pitch p becomes about 1.0 μm or smaller. Depending on applications, a yet greater deflection angle is demanded, and the optical deflecting device disclosed in PTL 1 has difficulty in satisfying that demand.

In view of the above-described points, it is an object of the present invention to provide an optical deflecting element that can be manufactured with a simple method and that can have a great deflection angle.

### Solution to Problem

An optical deflecting element according to the present invention is an optical deflecting element including a first substrate on which a first electrode is formed, a second substrate on which a second electrode is formed, and a liquid crystal layer arranged between the first electrode and the second electrode. At least one of the first electrode and the second electrode includes a plurality of first transparent electrodes, a plurality of second transparent electrodes, and an inter-layer film. When viewed from the direction of the normal of the first substrate, the plurality of first transparent electrodes and the plurality of second transparent electrodes are alternately arranged in stripes. The inter-layer film is formed on the plurality of first transparent electrodes. The plurality of second transparent electrodes are formed on the inter-layer film.

In a certain embodiment, the array pitch of the plurality of first transparent electrodes is equal to the array pitch of the plurality of second transparent electrodes.

In a certain embodiment, when viewed from the direction of the normal of the first substrate, a portion of one first transparent electrode among the plurality of first transparent electrode overlaps one second transparent electrode among the plurality of second transparent electrodes.

In a certain embodiment, the plurality of first transparent electrodes and the plurality of second transparent electrodes are electrically independent of one another.

In a certain embodiment, the liquid crystal layer is a vertical alignment nematic liquid crystal layer, a homogeneous alignment nematic liquid crystal layer, or a ferroelectric liquid crystal layer.

In a certain embodiment, the inter-layer film is formed of a transparent insulating resin.

### Advantageous Effects of Invention

According to the present invention, an optical deflecting element that can be manufactured with a simple method and that can have a great deflection angle is provided.

### BRIEF DESCRIPTION OF DRAWINGS

FIG. 1 is a schematic sectional view of an optical deflecting element 100A according to an embodiment of the present invention.

FIG. 2(a) is a graph showing the relationship between an etching shift amount and a line width; FIG. 2(b) is a plan view describing the etching shift amount; and FIG. 2(c) is a graph describing a phase modulation amount.

FIG. 3 is a diagram describing a diffraction grating pattern P1 of the optical deflecting element 100A.

FIG. 4(a) is a schematic sectional view of an optical deflecting device described in PTL 1; FIG. 4(b) is a schematic sectional view of the optical deflecting element 100A; FIG. 4(c) is a sectional view describing the electric field distribution of the optical deflecting device described in PTL 1; and FIG. 4(d) is a sectional view describing the electric field distribution of the optical deflecting element 100A.

FIG. 5(a) is a schematic sectional view of an optical deflecting element 100B according to another embodiment of the present invention; FIG. 5(b) is a sectional view describing a potential difference generated between transparent electrodes of the optical deflecting element 100B; FIG. 5(c) is a sectional view describing the electric field distribution of the optical deflecting element 100B; and FIG. 5(d) is a sectional view describing a diffraction grating pattern P2 of the optical deflecting element 100B.

FIG. 6(a) is a schematic sectional view of an optical deflecting element 100C according to yet another embodiment of the present invention; FIG. 6(b) is a sectional view describing the electric field distribution of the optical deflecting element 100C; and FIG. 6(c) is a sectional view describing a diffraction grating pattern P3 of the optical deflecting element 100C.

FIG. 7(a) is a schematic sectional view of an optical deflecting element 100D according to yet another embodiment of the present invention; FIG. 7(b) is a sectional view describing the electric field distribution of the optical deflecting element 100D; and FIG. 7(c) is a sectional view describing a diffraction grating pattern P4 of the optical deflecting element 100D.

FIG. 8 is a graph showing the relationship between the deflection angle (diffraction angle) and the array pitch of the transparent electrodes of light with a wavelength of 550 nm.

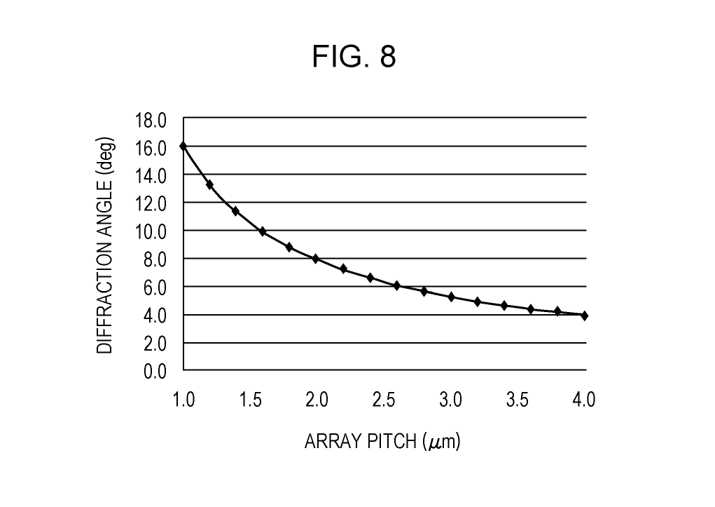

### DESCRIPTION OF EMBODIMENTS

Hereinafter, an optical deflecting element according to embodiments of the present invention will be described with reference to the drawings. The present invention is not limited to the embodiments described by way of example.

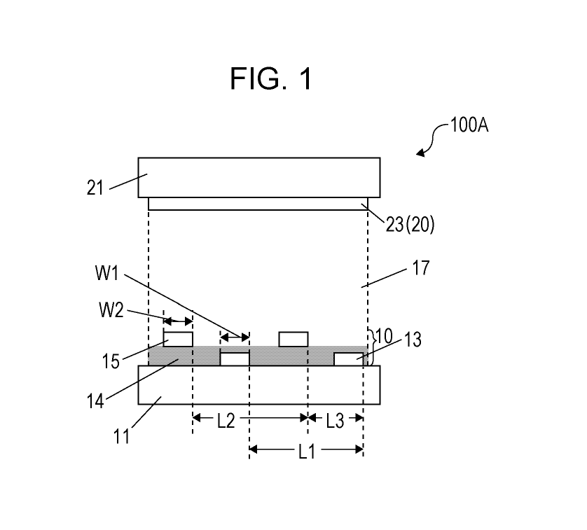

Referring to FIG. 1, an optical deflecting element 100A according to an embodiment of the present invention will be described. FIG. 1 is a schematic sectional view of the optical deflecting element 100A.

The optical deflecting element 100A shown in FIG. 1 includes a first substrate (such as a glass substrate) 11 on which a first electrode 10 is formed, a second substrate (such as a glass substrate) 21 on which a second electrode 20 is formed, and a liquid crystal layer 17 provided between the first electrode 10 and the second electrode 20. The first electrode 10 includes a plurality of first transparent electrodes 13, an inter-layer film 14 formed on the plurality of first transparent electrodes 13, and a plurality of second transparent electrodes 15 formed on the inter-layer film 14. The plurality of first and second transparent electrodes 13 and 15 are alternately formed in stripes. The plurality of first transparent electrodes 13 are electrically independent of one another. The plurality of second transparent electrodes 15 are electrically independent of one another. The second electrode 20 includes a transparent electrode (common electrode) 23 solidly formed on the entire element. The plurality of first and second transparent electrodes 13 and 15 and the transparent electrode 23 are each formed of, for example, ITO (Indium Tin Oxide). The plurality of first and second transparent electrodes 13 and 15 and the transparent electrode 23 may each be formed of, for example, IZO (Indium Zinc Oxide).

When viewed from the direction of the normal of the first substrate 11, one second transparent electrode 15 is formed between two adjacent first transparent electrodes 13, and one first transparent electrode 13 is formed between two adjacent second transparent electrodes 15. The array pitch L1 of the plurality of first transparent electrodes 13 is equal to the array pitch L2 of the plurality of second transparent electrodes. Also, when viewed from the direction of the normal of the first substrate 11, the array pitch L3 between the first transparent electrodes 13 and the second transparent electrodes 15 is (L1)/2 and (L2)/2 (L3=(L1)/2=(L2)/2). In the optical deflecting element 100A, the array pitch L1 or L2 corresponds to the grating pitch p of the above-described expressions (1).

Although details will be described later, in the optical deflecting element 100A with such a structure, high definition transparent electrodes in stripes can be formed with a simple method, and the width of the first transparent electrodes 13 and the width of the second transparent electrodes 15 can be made greater. Thus, a great deflection angle can be obtained.

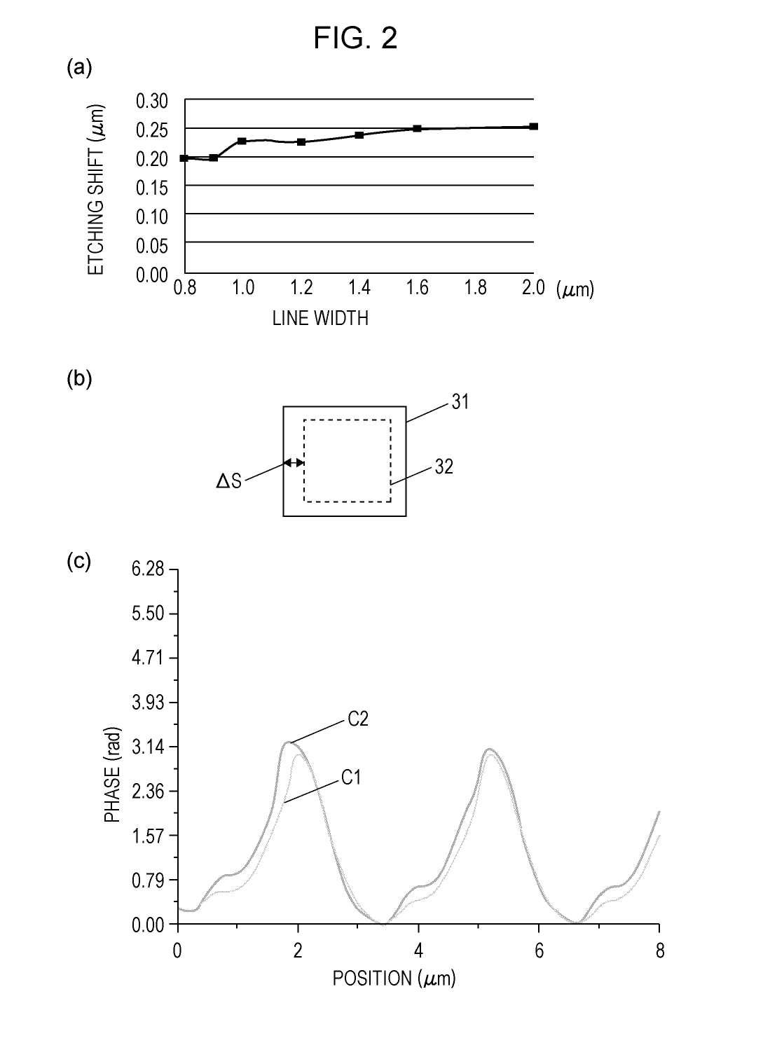

In general, photolithography is used in forming the transparent electrodes of the optical deflecting element 100A. FIG. 2(a) is a graph showing the difference (etching shift amount) between the line width of an electrode pattern formed on a photo mask and the line width of an etched electrode formed on a substrate when an electrode is patterned using photolithography. The line width of the electrode pattern formed on the photo mask is plotted in abscissa, and the etching shift amount is plotted in ordinate. Here, the etching shift amount will be described with reference to FIG. 2(b).

Photolithography uses a photo mask to form a desired electrode pattern on a substrate. As shown in FIG. 2(b), an electrode pattern 31 formed on the photo mask and an electrode pattern 32 formed on the substrate by using photolithography are usually different in pattern size. This is because etching may become over-etching, and the size of the electrode pattern 32 formed on the substrate becomes smaller than the size of the electrode pattern 31 formed on the photo mask (this phenomenon may be referred to as etching shift). An etching shift amount ΔS is the distance between a lateral face of the electrode pattern 31 formed on the photo mask and a lateral face of the electrode pattern 32 formed on the substrate.

With regard to the resolution of a stepper used in photolithography, L/S (line & space) is about 1.5 μm even in a stepper with a high resolution. When wet etching is employed, as shown in FIG. 2(a), an etching shift amount of about 0.2 μm exists. Therefore, in the case of the electrode structure of an optical deflecting device disclosed in PTL 1, even when a high definition electrode pattern is formed, it is considered that the limit is to have an electrode width of 0.5 μm and an electrode array pitch (grating pitch) of 1.5 μm.

In contrast, when an electrode structure with a two-layer structure as in the optical deflecting element 100A is adopted, transparent electrodes can be formed at a smaller electrode array pitch than that of the optical deflecting device disclosed in PTL 1. In general, because the alignment accuracy of a stepper is higher than the resolution of the stepper, an electrode structure with a two-layer structure as in the optical deflecting element 100A can have a smaller electrode array pitch. Although the electrode structure may have a three-layer structure, formation with a grating pitch smaller than that of a two-layer structure is considered to be difficult because of the relationship between the resolution and the alignment accuracy of a stepper.

The liquid crystal layer 17 is, for example, a nematic liquid crystal layer (called “homogeneous liquid crystal layer”) having nematic liquid crystal molecules with a homogeneous alignment when no voltage is applied. The nematic liquid crystal layer includes, for example, a nematic liquid crystal material whose anisotropy of dielectric constant is positive. Further, a refractive index anisotropy An of the nematic liquid crystal material is preferably greater than or equal to 0.1 and less than or equal to 1.0. The thickness d of the liquid crystal layer 17 is preferably greater than or equal to 3.0 μm and less than or equal to 8.0 μm. A retardation (Δn×d) is preferably greater than or equal to 300 nm and less than or equal to 800 nm. The liquid crystal layer 17 may be, for example, a nematic liquid crystal layer having nematic liquid crystal molecules with a spray alignment or a bend alignment. Further, the liquid crystal layer 17 may be a vertical alignment liquid crystal layer having nematic liquid crystal molecules with a vertical alignment with respect to the substrate. Alternatively, instead of the nematic liquid crystal layer, a ferroelectric liquid crystal layer with a ferroelectric liquid crystal material may be used. When a ferroelectric liquid crystal layer is used, because ferroelectric liquid crystal molecules have spontaneous polarization, due to a direct mutual operation between the electric field and the ferroelectric liquid crystal molecules, the response speed of the ferroelectric liquid crystal molecules can be made greater (μsec order) than the response speed of the nematic liquid crystal molecules (msec order).

Though not shown in FIG. 1, for example, horizontal alignment films are formed on the second transparent electrode 15 and the transparent electrode 23 so as to contact the liquid crystal layer 17 when no voltage is applied. Alternatively, instead of forming horizontal alignment films, desired alignment films may be formed in accordance with the alignment (such as a spray alignment) of the liquid crystal molecules of the liquid crystal layer 17.

The width W1 of the first transparent electrodes 13 and the width W2 of the second transparent electrodes 15 are preferably 0.4 μm≦W1, W2≦1.5 μm. When the width W1 of the first transparent electrodes 13 and the width W2 of the second transparent electrodes 15 are within such a range, a great deflection angle (such as 5° or greater) can be obtained. In the optical deflecting element 100A, W1=W2=0.5 μm. For example, when the ratio between the widths W1 and W2 of the transparent electrodes 13 and 15 and the distance between the transparent electrodes 13 and 15 is 1:1 (line width:space width=1:1), the widths W1 and W2 of the transparent electrodes 13 and 15 are preferably less than or equal to 1.5 μm. When the widths W1 and W2 of the transparent electrodes 13 and 15 are less than or equal to 1.5 μm, the deflection angle becomes 5° or greater. The thicknesses of the first and second transparent electrodes 13 and 15 are each greater than or equal to 100 nm and less than or equal to 150 nm. The smaller the thicknesses of the transparent electrodes 13 and 15, the greater the surface resistances. The greater the thicknesses of the transparent electrodes 13 and 15, the smaller the transmission. When the thicknesses of the transparent electrodes 13 and 15 are within the above-described range, the surface resistances of the transparent electrodes 13 and 15 become greater than or equal to 5 Ω/□ and less than or equal to 40 Ω/□, and the light transmission in a visible light region becomes greater than or equal to 85%. The greater the widths of the first and second transparent electrodes 13 and 15, the smaller the resistances of the electrodes. Thus, a driving voltage can be reduced. Also, the greater the widths of the transparent electrodes 13 and 15, the greater a phase modulation amount and a diffraction efficiency.

FIG. 2(c) is a graph describing the phase modulation amount when the widths W1 and W2 of the first and second transparent electrodes 13 and 15 are different. The graph shown in FIG. 2(c) is a graph based on a simulation result. A curve C1 shown in FIG. 2(c) is a phase modulation amount curve when the array pitch of the first and second transparent electrodes 13 and 15 is 1.6 μm (L3=1.6 μm), and the widths of the first and second transparent electrodes are 0.4 μm (W1=W2=0.4 μl). A curve C2 shown in FIG. 2(c) is a phase modulation amount curve when the array pitch of the first and second transparent electrodes 13 and 15 is 1.6 μm (L3=1.6 μm), and the widths of the first and second transparent electrodes are 0.8 μm (W1=W2=0.8 μm).

As is clear from FIG. 2(c), the greater the widths of the transparent electrodes, the greater the phase modulation amount. As a result, the diffraction angle becomes greater.

The array pitches L1 and L2 of the plurality of first and second transparent electrodes 13 and 15 preferably satisfy 1.4 μm≦L1, L2≦6.0 μm. When the array pitches L1 and L2 of the plurality of first and second transparent electrodes 13 and 15 are within such a range, a great deflection angle can be obtained. In the optical deflecting element 100A, L1=L2=2.0 μm, and L3=(L1)/2=(L2)/2=1.0 μm. It is considered that to form the transparent electrodes 13 and 15 to satisfy L1, L2<1.4 μm is difficult due to the capability of a stepper. When L1, L2>6.0 μm, a great deflection angle (such as a deflection angle of 5° or greater) cannot be obtained.

The inter-layer film 14 is, for example, a transparent insulating film. Specifically, the inter-layer film 14 is formed of a photographic sensitive acrylic resin. The inter-layer film 14 may be formed of, for example, a photographic sensitive polyimide resin. Further, the inter-layer film 14 may be formed of, for example, SiO₂ (silicon dioxide). The thickness of the inter-layer film 14 is, for example, greater than or equal to 0.1 μm and less than or equal to 0.5 μm. The greater the thickness of the inter-layer film 14, the smaller the phase modulation amount. Thus, the thickness of the inter-layer film 14 is preferably less than or equal to 0.5 μm in order not to reduce the phase modulation amount (reduction amount is 10% or smaller).

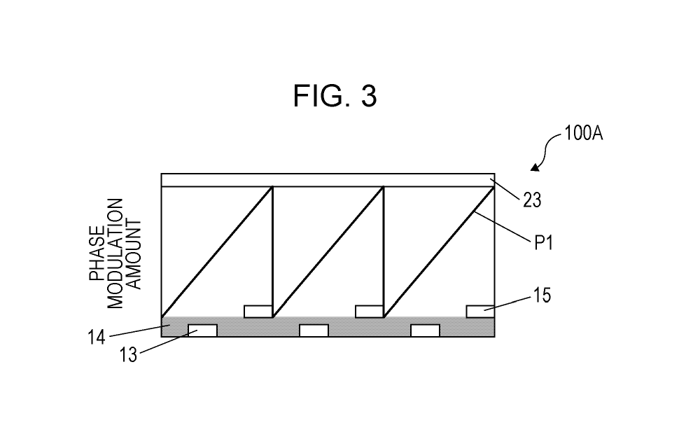

FIG. 3 is a diagram describing a diffraction grating pattern P1 of the optical deflecting element 100A. A voltage of, for example, 0 V is applied to each of the plurality of first transparent electrodes 13. A voltage of, for example, +5 V is applied to each of the plurality of second transparent electrodes 15. A voltage of, for example, 0 V is applied to the transparent electrode 23. In FIG. 3, the diffraction grating pattern P1 has a greater phase modulation amount as the diffraction grating pattern P1 becomes closer to the transparent electrode 23.

As shown in FIG. 3, a spatial refractive index modulated region is induced in the liquid crystal layer 17 of the optical deflecting element 100A, thereby forming a blazed diffraction grating. A sine-wave-shaped diffraction grating or a rectangular-wave-shaped diffraction grating may be formed by adjusting the applied voltages.

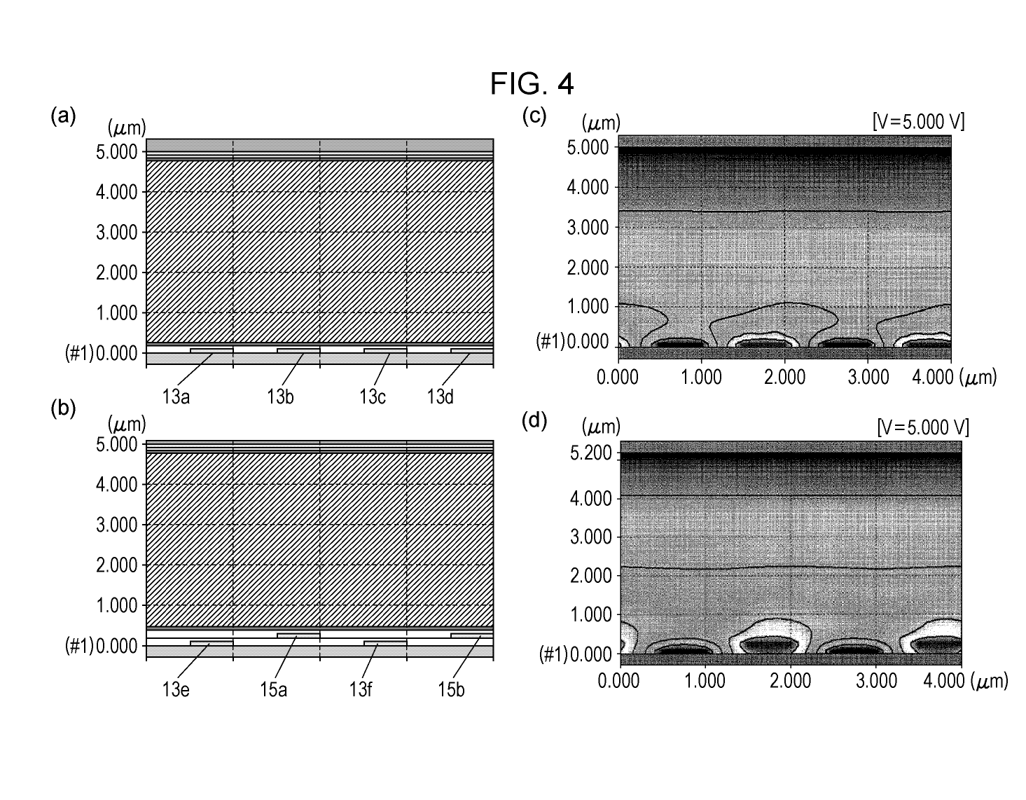

FIG. 4 includes diagrams describing the electric field distribution of the optical deflecting element 100A and the electric field distribution of the optical deflecting device (referred to as an optical deflecting device 200) disclosed in PTL 1. FIG. 4(a) is a sectional view of the optical deflecting device 200. FIG. 4(b) is a sectional view of the optical deflecting element 100A. FIG. 4(c) is a diagram describing the electric field distribution of the optical deflecting device 200. FIG. 4(d) is a diagram describing the electric field distribution of the optical deflecting element 100A. A voltage of, for example, +5 V is applied to each of transparent electrodes 13b, 13d, 15a, and 15b. A voltage of, for example, 0 V is applied to each of transparent electrodes 13a, 13c, 13e, and 13f.

As is clear from FIG. 4(c) and FIG. 4(d), the optical deflecting device 200 and the optical deflecting element 100A exhibit similar electric field distributions, and it is expected that the optical deflecting device 200 and the optical deflecting element 100A form similar blazed diffraction gratings. Therefore, even when the electrode structure has a two-layer structure as in the optical deflecting element 100A, it is expected that there will be no affect on formation of a blazed diffraction grating.

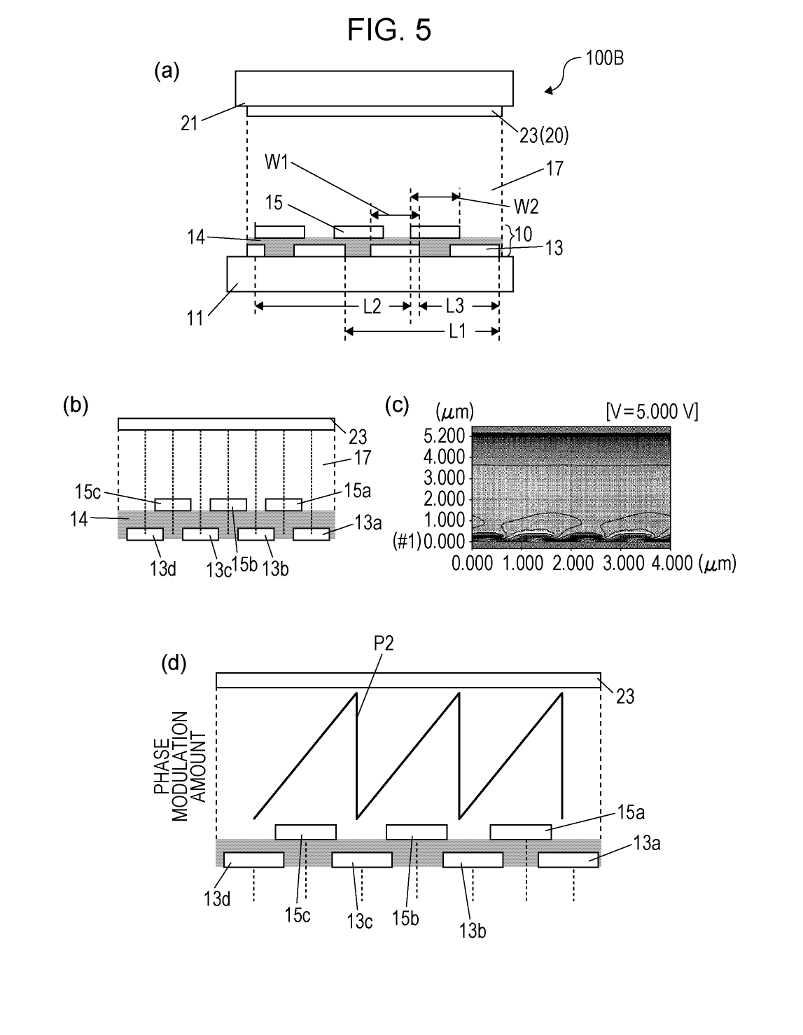

Next, an optical deflecting element 100B according to another embodiment of the present invention will be described with reference to FIG. 5. Elements common to those of the optical deflecting element 100A are given the same reference numerals, and overlapping descriptions are omitted.

FIG. 5(a) is a schematic sectional view of the optical deflecting element 100B. The optical deflecting element 100B shown in FIG. 5(a) includes the first substrate (such as a glass substrate) 11 on which the first electrode 10 is formed, the second substrate (such as a glass substrate) 21 on which the second electrode 20 is formed, and the liquid crystal layer 17 provided between the first electrode 10 and the second electrode 20. The first electrode 10 includes the plurality of first transparent electrodes 13, the inter-layer film 14 formed on the plurality of first transparent electrodes 13, and the plurality of second transparent electrodes 15 formed on the inter-layer film 14. The plurality of first and second transparent electrodes 13 and 15 are alternately formed in stripes. The plurality of first transparent electrodes 13 are electrically independent of one another. The plurality of second transparent electrodes 15 are electrically independent of one another. The second electrode 20 includes the transparent electrode (common electrode) 23 solidly formed on the entire element.

When viewed from the direction of the normal of the first substrate 11, one second transparent electrode 15 is formed between two adjacent first transparent electrodes 13, and one first transparent electrode 13 is formed between two adjacent second transparent electrodes 15. Further, when viewed from the direction of the normal of the first substrate 11, among the plurality of first transparent electrodes 13, a portion of one transparent electrode 13 overlaps, among the plurality of second transparent electrodes 15, at least one second transparent electrode 15 adjacent to one first transparent electrode 13. The array pitch L1 of the plurality of first transparent electrodes 13 is equal to the array pitch L2 of the plurality of second transparent electrodes. The array pitch L3 between the first transparent electrodes 13 and the second transparent electrodes 15 is (L1)/2 and (L2)/2 (L3=(L1)/2=(L2)/2). In the optical deflecting element 100B, the array pitch L1 or L2 corresponds to the grating pitch p of the above-described expressions (1).

Although details will be described later, in the optical deflecting element 100B with such a structure, the array pitch (L3) between the first transparent electrodes 13 and the second transparent electrodes 15 can be made smaller than that in the optical deflecting element 100A. Thus, a deflection angle greater than that of the optical deflecting element 100A can be obtained. Further, since the optical deflecting element 100B has a structure in which, when viewed from the direction of the normal of the first substrate 11, a portion of one transparent electrode 13 overlaps at least one second transparent electrode 15 adjacent to one first transparent electrode 13, the widths of the first transparent electrodes 13 and the second transparent electrodes 15 can be made greater, and the array pitch (L3) between the first transparent electrodes 13 and the second transparent electrodes 15 can be made smaller without reducing the electrical resistances of the transparent electrodes. As a result, the electrical resistances of the transparent electrodes can be made smaller than that in the optical deflecting element 100A, and a greater deflection angle can be obtained.

The width W1 of the first transparent electrodes 13 and the width W2 of the second transparent electrodes 15 are preferably 0.4 μm≦W1, W2≦1.5 μm. In the optical deflecting element 100B, W1=W2=0.5 μm. The thicknesses of the first and second transparent electrodes 13 and 15 are each greater than or equal to 100 nm and less than or equal to 150 nm. The greater the widths of the transparent electrodes 13 and 15, the smaller the resistances of the electrodes. Accordingly, a driving voltage can be reduced. Further, the greater the widths of the transparent electrodes 13 and 15, the greater the phase modulation amount, and the greater the diffraction efficiency.

The array pitches L1 and L2 preferably satisfy 1.4 μm≦L1, L2≦6.0 μm. When the array pitches L1 and L2 are within such a range, a great deflection angle can be obtained. In the optical deflecting element 100B, L1=L2=2.0 μm, and L3=L1/2=L2/2=1.0 μm. It is considered that to form the transparent electrodes to satisfy L1, L2<1.4 μm is difficult due to the capability of a manufacturing apparatus. When L1, L2>6.0 μm, a great deflection angle cannot be obtained.

Next, the diffraction grating pattern of the optical deflecting element 100B will be described. FIG. 5(b) is a sectional view describing voltages applied to the electrodes (the plurality of first transparent electrodes 13, the plurality of second transparent electrodes 15, and the transparent electrode 23). FIG. 5(c) is a sectional view describing the electric field distribution of the optical deflecting element 100B upon application of desired voltages to the electrodes 13 and 15. FIG. 5(d) is a sectional view describing a diffraction grating pattern P2 of the optical deflecting element 100B upon application of desired voltages to the electrodes 13 and 15.

As shown in FIG. 5(b), for example, it is assumed that a voltage of +5 V is applied to the first transparent electrodes 13b and 13d and the second transparent electrodes 15a and 15c, and a voltage of 0 V is applied to the first transparent electrodes 13a and 13c, the second transparent electrode 15b, and the transparent electrode 23. In this case, a potential difference generated between the first transparent electrode 13a and the second transparent electrode 15a is −5 V. Similarly, a potential difference generated between the first transparent electrode 13b and the second transparent electrode 15a is 0 V. A potential difference generated between the first transparent electrode 13b and the second transparent electrode 15b is +5 V. A potential difference generated between the first transparent electrode 13c and the second transparent electrode 15b is 0 V. A potential difference generated between the first transparent electrode 13c and the second transparent electrode 15c is −5 V. A potential difference generated between the first transparent electrode 13d and the second transparent electrode 15c is 0 V. As a result, the optical deflecting element 100B exhibits an electric field distribution such as that shown in FIG. 5(c). The electric field distribution shown in FIG. 5(c) is an electric field distribution similar to that of the above-described optical deflecting element 100A (see FIG. 1(d)). Also, the diffraction grating pattern P2, such as that shown in FIG. 5(d), is formed. The diffraction grating pattern P2 has a greater phase modulation amount as the diffraction grating pattern P2 becomes closer to the transparent electrode 23. The diffraction grating pattern P2 is a blazed diffraction grating pattern.

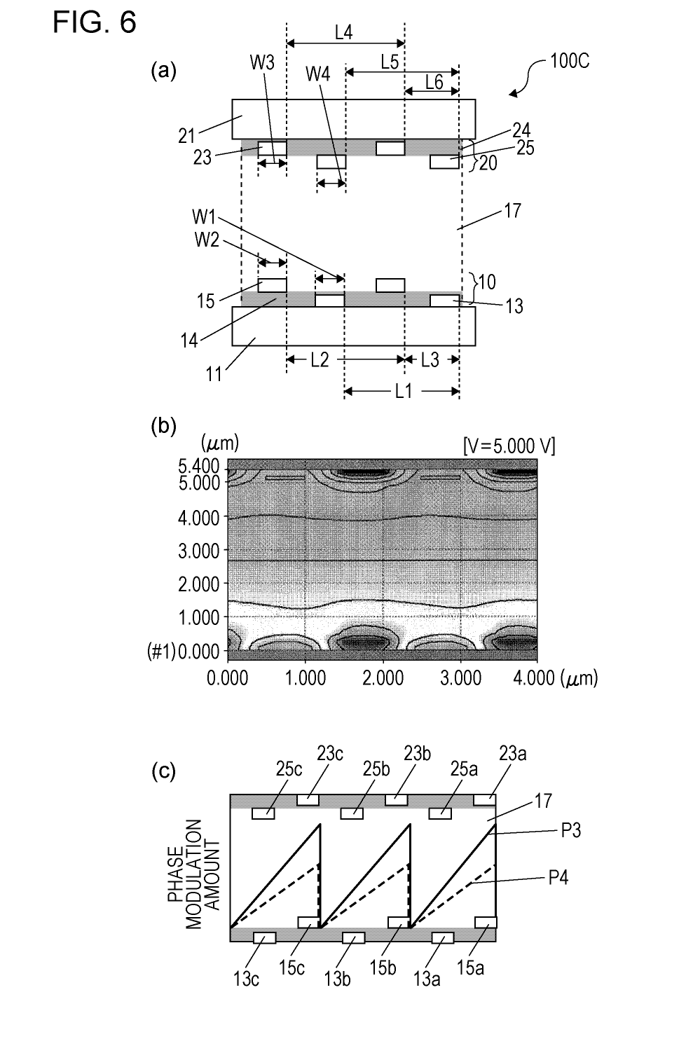

Next, an optical deflecting element 100C according to yet another embodiment of the present invention will be described with reference to FIG. 6. Elements common to those of the optical deflecting element 100A are given the same reference numerals, and overlapping descriptions are omitted.

FIG. 6(a) is a schematic sectional view of the optical deflecting element 100C. The optical deflecting element 100C is an optical deflecting element in which the electrode structure of the second electrode 20 of the optical deflecting element 100A has a two-layer structure. Specifically, the optical deflecting element 100C shown in FIG. 6(a) includes the first substrate (such as a glass substrate) 11 on which the first electrode 10 is formed, the second substrate (such as a glass substrate) 21 on which the second electrode 20 is formed, and the liquid crystal layer 17 provided between the first electrode 10 and the second electrode 20. The first electrode 10 includes the plurality of first transparent electrodes 13, the inter-layer film 14 formed on the plurality of first transparent electrodes 13, and the plurality of second transparent electrodes 15 formed on the inter-layer film 14. The plurality of first and second transparent electrodes 13 and 15 are alternately formed in stripes. The plurality of first transparent electrodes 13 are electrically independent of one another. The plurality of second transparent electrodes 15 are electrically independent of one another. The second electrode 20 includes a plurality of third transparent electrodes 23, an inter-layer film 24 formed on the plurality of third transparent electrodes 23, and a plurality of fourth transparent electrodes 25 formed on the inter-layer film 24. The plurality of third transparent electrodes 23 and fourth transparent electrodes 25 are alternately formed in stripes. The plurality of third transparent electrodes 23 are electrically independent of one another. The plurality of fourth transparent electrodes 25 are electrically independent of one another. The plurality of first, second, third, and fourth transparent electrodes 13, 15, 23, and 25 are each formed of, for example, ITO. The plurality of first, second, third, and fourth transparent electrodes 13, 15, 23, and 25 may each be formed of, for example, IZO. The inter-layer film 24 is formed of the same material as that from which the above-described inter-layer film 14 can be formed.

When viewed from the direction of the normal of the first substrate 11, one second transparent electrode 15 is formed between two adjacent first transparent electrodes 13, and one first transparent electrode 13 is formed between two adjacent second transparent electrodes 15. The array pitch L1 of the plurality of first transparent electrodes 13 is equal to the array pitch L2 of the plurality of second transparent electrodes. The array pitch L3 between the first transparent electrodes 13 and the second transparent electrodes 15 is (L1)/2 and (L2)/2 (L3=(L1)/2=(L2)/2).

Further, when viewed from the direction of the normal of the first substrate 11, one fourth transparent electrode 25 is formed between two adjacent third transparent electrodes 23, and one third transparent electrode 23 is formed between two adjacent fourth transparent electrodes 25. The array pitch L4 of the plurality of third transparent electrodes 23 is equal to the array pitch L5 of the plurality of fourth transparent electrodes. The array pitch L6 between the third transparent electrodes 23 and the fourth transparent electrodes 25 is (L4)/2 and (L5)/2 (L6=(L4)/2=(L5)/2). The third and fourth transparent electrodes 23 and 25 may be formed under, for example, the same condition as the first and second transparent electrodes 13 and 15.

Although details will be described later, the optical deflecting element 100C with such a structure can have a greater potential difference applied to the liquid crystal layer 17 than that in the optical deflecting element 100A. Thus, the phase modulation amount can be made greater, and the diffraction efficiency can be enhanced.

The widths W1 and W2 of the first and second transparent electrodes 13 and 15 and the widths W3 and W4 of the third and fourth transparent electrodes 23 and 25 are preferably 0.4 μm≦W1, W2, W3, W4≦1.5 μm. In the optical deflecting element 100C, W1=W2=W3=W4=0.4 μm. The thicknesses of the transparent electrodes 13, 15, 23, and 25 are each greater than or equal to 50 nm and less than or equal to 150 nm. The greater the widths of the transparent electrodes 13, 15, 23, and 25, the smaller the resistances of the electrodes. Accordingly, a driving voltage can be reduced. Further, the phase modulation amount can be made greater, and the diffraction efficiency can be enhanced.

The array pitches L1, L2, L4, and L5 preferably satisfy 1.4 μm≦L1, L2, L4, L5≦6.0 μm. When the array pitches L1, L2, L4, and L5 are within such a range, a great deflection angle can be obtained. In the optical deflecting element 100C, L1=L2=L4=L5=2.0 μm, and L3=L1/2=L2/2=L6=L4/2=L5/2=1.0 μm. It is considered that to form the transparent electrodes to satisfy L1, L2, L4, L5<1.4 μm is difficult due to the capability of a manufacturing apparatus. When L1, L2, L4, L5>6.0 μm, a great deflection angle cannot be obtained.

Next, the diffraction grating pattern of the optical deflecting element 100C will be described. FIG. 6(b) is a sectional view describing the electric field distribution of the optical deflecting element 100C upon application of desired voltages to the electrodes (the first to fourth transparent electrodes 13, 15, 23, and 25). FIG. 6(c) is a sectional view describing a diffraction grating pattern P3 upon application of desired voltages to the electrodes (the first to fourth electrodes 13, 15, 23, and 25). The diffraction grating pattern P1 shown in FIG. 6(c) is the diffraction grating pattern of the above-described optical deflecting element 100A. The diffraction grating patterns P1 and P3 each have a greater phase modulation amount as the diffraction grating patterns P1 and P3 become closer to the transparent fourth transparent electrodes 25.

As shown in FIG. 6(b), the optical deflecting element 100C exhibits an electric field distribution similar to that of the above-described optical deflecting element 100A (see FIG. 4(d)). As a result, as shown in FIG. 6(c), for example, it is assumed that a voltage of +5 V is applied to the second transparent electrodes 15a to 15c, a voltage of −5 V is applied to third transparent electrodes 23a to 23c, and a voltage of 0 V is applied to the first transparent electrodes 13a to 13c and fourth transparent electrodes 25a to 25c. In this case, the diffraction grating pattern P3 shown in FIG. 6(c) is formed. Also, as is clear from FIG. 6(c), the diffraction grating pattern P3 obtained with the optical deflecting element 100C has a greater phase modulation amount than that obtained by the diffraction grating pattern P1 obtained with the optical deflecting element 100A within the same voltage application range (range from −5 V to +5 V). As a result, the optical deflecting element 100C has a higher diffraction efficiency than the optical deflecting element 100A. This is because, in the optical deflecting element 100C, since the plurality of first to fourth transparent electrodes are electrically independent of one another, a greater potential difference than that in the optical deflecting element 100A is generated at the liquid crystal layer 17. p In the optical deflecting element 100C, even when misalignment occurs between the first substrate 11 and the second substrate 21 and the corresponding relationship between the first and second transparent electrodes 13 and 15 and the third and fourth transparent electrodes 23 and 25 becomes shifted, it is only necessary to apply desired voltages to the transparent electrodes from, for example, an IC (Integrated Circuit) driver so that a desired diffraction grating pattern and a desired phase modulation amount are obtained in accordance with the amount of misalignment. Specifically, when the transparent electrodes 23 and 25 are shifted, for example, 0.5 μm to the left (left in FIG. 6(a)) due to the misalignment, if a voltage of −5 V is applied to the third transparent electrodes 23a to 23c and a voltage of 0 V is applied to the fourth transparent electrodes 25a to 25c as in the same condition as the above-described voltage application condition, the phase modulation amount is reduced, compared with the case where there is no misalignment. However, when a voltage of 0 V is applied to the third transparent electrodes 23a to 23c and a voltage of −5 V is applied to the fourth transparent electrodes 25a to 25c, a reduction of the phase modulation amount is suppressed, and a phase modulation amount at the same level as the case where there is no misalignment can be obtained. In this way, a desired diffraction grating pattern and a desired phase modulation amount can be obtained by changing voltages applied to the electrodes in accordance with the misalignment.

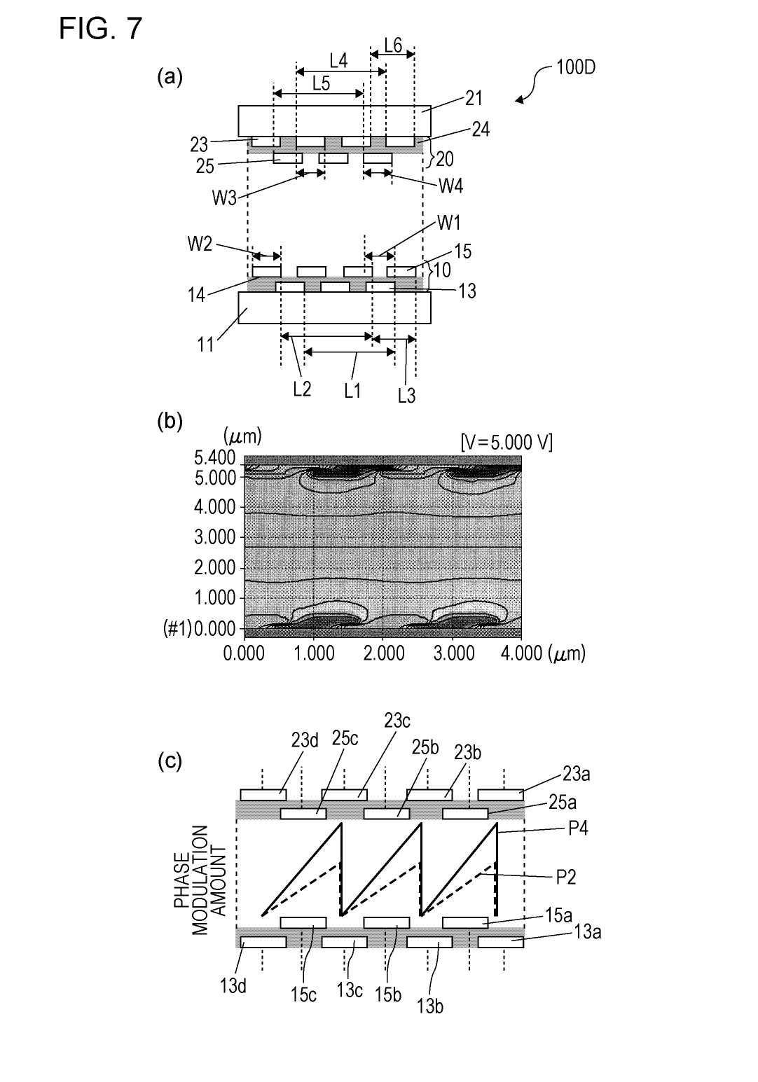

Next, an optical deflecting element 100D according to yet another embodiment of the present invention will be described with reference to FIG. 7. The optical deflecting element 100D shown in FIG. 7(a) is an optical deflecting element with a structure in which, when viewed from the direction of the normal of the first substrate 11, a portion of one first transparent electrode 13 of the optical deflecting element 100C overlaps at least one second transparent electrode 15 adjacent to one first transparent electrode 13, and a portion of one third transparent electrode 23 overlaps at least one fourth transparent electrode adjacent to one third transparent electrode 23.

In the optical deflecting element 100D, the array pitch L3 between the first transparent electrodes 13 and the second transparent electrodes 15 is (L1)/2 and (L2)/2 (L3=(L1)/2=(L2)/2). Similarly, the array pitch L6 between the third transparent electrodes 23 and the fourth transparent electrodes 25 is (L4)/2 and (L5)/2 (L6=(L4)/2=(L5)/2).

Although details will be described later, the optical deflecting element 100D with such a structure can have a greater potential difference generated at the liquid crystal layer 17 than that in the optical deflecting element 100B or in the optical deflecting element 100C. Thus, the phase modulation amount can be made greater, and the diffraction efficiency can be enhanced. Further, the optical deflecting element 100D can have a smaller grating pitch p than that in the optical deflecting element 100C, and hence, the optical deflecting element 100D can have a greater deflection angle than that in the optical deflecting element 100C.

The widths W1 and W3 of the first and third transparent electrodes 13 and 23 and the widths W2 and W4 of the second and fourth transparent electrodes 15 are preferably 0.4 μm≦W1, W2, W3, W4≦1.5 μm. In the optical deflecting element 100D, W1=W2=W3=W4=0.6 μm. The thicknesses of the transparent electrodes 13, 15, 23, and 25 are each greater than or equal to 100 nm and less than or equal to 150 nm.

The array pitches L1, L2, L4, and L5 preferably satisfy 1.4 μm≦L1, L2, L4, L5≦6.0 μm. When the array pitches L1, L2, L4, and L5 are within such a range, a great deflection angle can be obtained. In the optical deflecting element 100D, L1=L2=L4=L5=2.0 μm, and L3=L1/2=L2/2=L6=L4/2=L5/2=1.0 μm. It is considered that to form the transparent electrodes to satisfy L1, L2, L4, L5<1.4 μm is difficult due to the capability of a manufacturing apparatus. When L1, L2, L4, L5>6.0 μm, a great deflection angle cannot be obtained.

Next, the diffraction grating pattern of the optical deflecting element 100D will be described. FIG. 7(b) is a sectional view describing the electric field distribution of the optical deflecting element 100D upon application of desired voltages to the electrodes (the first to fourth transparent electrodes 13, 15, 23, and 25). FIG. 7(c) is a sectional view describing a grating diffraction pattern P4 upon application of desired voltages to the electrodes (the first to fourth transparent electrodes 13, 15, 23, and 25).

As shown in FIG. 7(b), for example, it is assumed that a voltage of +5 V is applied to the first transparent electrodes 13b and 13d and the second transparent electrodes 15a and 15c, a voltage of −5 V is applied to the third transparent electrodes 23b and 23d and the fourth transparent electrode 25b, and a voltage of 0 V is applied to the first transparent electrodes 13a and 13c, the second transparent electrode 15b, the third transparent electrodes 23a and 23c, and the fourth transparent electrodes 25a and 25c. In this case, a potential difference generated between the first transparent electrode 13a and the second transparent electrode 15a is −5 V. A potential difference generated between the first transparent electrode 13b and the second transparent electrode 15a is 0 V. A potential difference generated between the first transparent electrode 13b and the second transparent electrode 15b is +5 V. A potential difference generated between the first transparent electrode 13c and the second transparent electrode 15b is 0 V. A potential difference generated between the first transparent electrode 13c and the second transparent electrode 15c is −5 V. A potential difference generated between the first transparent electrode 13d and the second transparent electrode 15c is 0 V. Similarly, a potential difference generated between the third transparent electrode 23a and the fourth transparent electrode 25a is 0 V. A potential difference generated between the third transparent electrode 23b and the fourth transparent electrode 25a is −5 V. A potential difference generated between the third transparent electrode 23b and the fourth transparent electrode 25b is 0 V. A potential difference generated between the third transparent electrode 23c and the fourth transparent electrode 25b is +5 V. A potential difference generated between the third transparent electrode 23c and the fourth transparent electrode 25c is 0 V. A potential difference generated between the third transparent electrode 23d and the fourth transparent electrode 25c is −5 V. As a result, as shown in FIG. 7(b), the optical deflecting element 100D exhibits an electric field distribution similar to that of the optical deflecting element 100B (see FIG. 5(c)). As shown in FIG. 7(c), the optical deflecting element 100D applies a greater potential difference to the liquid crystal layer 17 than the optical deflecting element 100B does, and the diffraction grating pattern P4 is formed. The diffraction grating pattern P4 in the case of an electrode structure such as that shown in FIG. 7(c) has a phase modulation amount greater than that of the above-described diffraction grating pattern P2, and the diffraction efficiency is enhanced.

In the optical deflecting element 100D, as in the case of the optical deflecting element 100C, even when misalignment occurs between the first substrate 11 and the second substrate 21 and the corresponding relationship between the first and second transparent electrodes and the third and fourth transparent electrodes becomes shifted, it is only necessary to apply desired voltages to the transparent electrodes from, for example, an IC (Integrated Circuit) driver so that a desired diffraction grating pattern and a desired phase modulation amount are obtained in accordance with the amount of misalignment. Specifically, when the transparent electrodes 23 and 25 are shifted, for example, 1.0 μm to the left (left in FIG. 7(a)) due to the misalignment, if voltages are applied under the same condition as that in the case where there is no misalignment, 0 V is applied to the third transparent electrodes 23b and 23d and the fourth transparent electrode 25b, and −5 V is applied to the third transparent electrodes 23a and 23c and the fourth transparent electrodes 25a and 25c. Accordingly, no desired diffraction grating pattern is obtained, or the phase modulation amount is reduced. However, a desired diffraction grating pattern and a desired phase modulation amount can be obtained by changing voltages applied from the IC driver to the transparent electrodes in accordance with the misalignment so that −5 V is applied to the third transparent electrodes 23b and 23d and the fourth transparent electrode 25b and 0 V is applied to the third transparent electrodes 23a and 23c and the fourth transparent electrodes 25a and 25c.

As described above, according to the embodiments of the present invention, an optical deflecting element that can be manufactured with a simple method and that can obtain a high deflection angle is provided.

### INDUSTRIAL APPLICABILITY

The present invention is applicable to, for example, mobile device such as a cellular phone or a portable video game machine. The present invention is further applicable to an optical scanner of a laser display or the like. The present invention can also be used as an optical switch for optical communication.

### REFERENCE SIGNS LIST

11, 21 substrates
13, 15, 23 transparent electrodes
14 inter-layer film
17 liquid crystal layer
L1, L2, L3 array pitches
W1, W2 transparent electrode widths

1. An optical deflecting element comprising:
a first substrate on which a first electrode is formed;
a second substrate on which a second electrode is formed; and
a liquid crystal layer arranged between the first electrode and the second electrode,
wherein at least one of the first electrode and the second electrode includes a plurality of first transparent electrodes, a plurality of second transparent electrodes, and an inter-layer film,
when viewed from the direction of the normal of the first substrate, the plurality of first transparent electrodes and the plurality of second transparent electrodes are alternately arranged in stripes,
the inter-layer film is formed on the plurality of first transparent electrodes, and
the plurality of second transparent electrodes are formed on the inter-layer film.

2. The optical deflecting element according to claim 1, wherein the array pitch of the plurality of first transparent electrodes is equal to the array pitch of the plurality of second transparent electrodes.

3. The optical deflecting element according to claim 1, wherein, when viewed from the direction of the normal of the first substrate, a portion of one first transparent electrode among the plurality of first transparent electrodes overlaps one second transparent electrode among the plurality of second transparent electrodes.

4. The optical deflecting element according to claim 1, wherein the plurality of first transparent electrodes and the plurality of second transparent electrodes are electrically independent of one another.

5. The optical deflecting element according to claim 1, wherein the liquid crystal layer is a vertical alignment nematic liquid crystal layer, a homogeneous alignment nematic liquid crystal layer, or a ferroelectric liquid crystal layer.

6. The optical deflecting element according to claim 1, wherein the inter-layer film is formed of a transparent insulating resin.
